(19) United States
(12) Patent Application Publication
(10) Pub. No.: US 2020/0333618 A1
(43) Pub. Date: Oct. 22, 2020

(54) Imaging Device and Multi-Eye Imaging Device

(71) Applicant: Hitachi Automotive Systems, Ltd., Hitachinaka-shi, Ibaraki (JP)

(72) Inventors: Akihiro YAMAGUCHI, Tokyo (JP); Hidenori SHINOHARA, Hitachinaka-shi (JP); Kenichi TAKEUCHI, Hitachinaka-shi (JP); Takashi MIYAZAKI, Hitachinaka-shi (JP); Hiroyuki KUDO, Hitachinaka-shi (JP)

(21) Appl. No.: 16/757,034

(22) PCT Filed: Oct. 11, 2018
(86) PCT No.: PCT/JP2018/037989

§ 371 Date: Apr. 17, 2020

(30) Foreign Application Priority Data
Oct. 24, 2017 (JP) 2017-205511

(51) Int. Cl. G02B 27/62; G03B 17/12; G02B 7/02

(52) U.S. Cl. CPC G02B 27/62; G02B 7/025; G03B 17/12

(57) ABSTRACT

Provided is an imaging device having a first substrate and a second substrate, the imaging device including an insertion hole provided to the first substrate and penetrating from a first side to a second side, a projection provided to the second substrate, inserted into the insertion hole from the first side, and bonded to the first substrate by a first adhesive agent, a first contact portion provided to the first substrate and in contact with the second substrate, a second contact portion provided to the second substrate and in contact with the first contact portion in the first substrate, a first bonding portion provided to the first substrate and bonded to the second substrate by a second adhesive agent, and a second bonding portion provided to the second substrate and bonded to the first bonding portion in the first substrate by the second adhesive agent, wherein the first adhesive agent projects from an inside of the insertion hole to the second side.

### TECHNICAL FIELD

The present invention relates to an imaging device and a multi-eye imaging device.

### BACKGROUND ART

In recent years, imaging devices have been used in various fields. PTL 1 discloses a lens attachment mechanism including a lens holder holding an image pickup lens, and a case having an insertion hole into which the lens holder is inserted, wherein an insertion part inserted into the insertion hole of the case in an insertion direction which is an optical axis direction of the image pickup lens and a regulation part for regulating the insertion are formed in the lens holder, engaging parts are provided on a surface opposed to the case of the regulation part of the lens holder and on a surface opposed to the regulation part of the case, and in the engaging part, the position of the lens holder relative to the case is formed adjustably in a state where the engaging part of the surface opposed to the case and the engaging part of the surface opposed to the regulation part are engaged.

### CITATION LIST

### Patent Literature

PTL 1: WO2014/020987

### SUMMARY OF INVENTION

### Technical Problem

In the invention described in PTL 1, a positional shift may occur in the fixing position of the optical component when the adhesive agent is cured.

### Solution to Problem

An imaging device according to a first aspect of the present invention is an imaging device having a first substrate and a second substrate, the imaging device including an insertion hole provided to the first substrate and penetrating from a first side to a second side, a projection provided to the second substrate, inserted into the insertion hole from the first side, and bonded to the first substrate by a first adhesive agent, a first contact portion provided to the first substrate and in contact with the second substrate, a second contact portion provided to the second substrate and in contact with the first contact portion in the first substrate, a first bonding portion provided to the first substrate and bonded to the second substrate by a second adhesive agent, and a second bonding portion provided to the second substrate and bonded to the first bonding portion in the first substrate by the second adhesive agent, wherein the first adhesive agent projects from an inside of the insertion hole to the second side.

A multi-eye imaging device according to a second aspect of the present invention is a multi-eye imaging device that includes two of the imaging devices described above, wherein the two imaging devices are arranged so that their optical axes are substantially parallel, and at least two of the projection, the insertion hole, and the first contact portion are arranged side by side in a direction connecting the two imaging devices.

### Advantageous Effects of Invention

According to the present invention, it is possible to suppress a positional shift of the fixing position of the optical component that occurs when the adhesive agent is cured.

### BRIEF DESCRIPTION OF DRAWINGS

FIG. 1 is an exploded perspective view of an imaging device 100.

FIG. 2 is a cross-sectional view of the imaging device 100.

FIG. 3 is a view describing an assembly process of fixing a lens holder 120 and a housing 150.

FIG. 4 is a view illustrating a comparative example.

FIG. 5 is a cross-sectional view of the imaging device 100 according to a first modification.

FIG. 6 is a cross-sectional view of an imaging device 100A according to a second embodiment.

FIG. 7 is a cross-sectional view of an imaging device 100B according to a third embodiment.

FIG. 8 is a schematic view of a multi-eye imaging device 300 including two imaging devices.

### DESCRIPTION OF EMBODIMENTS

### First Embodiment

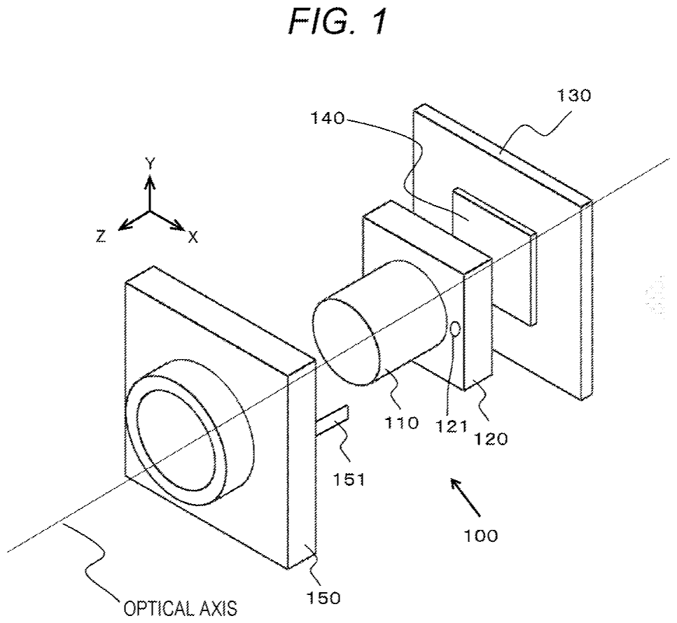

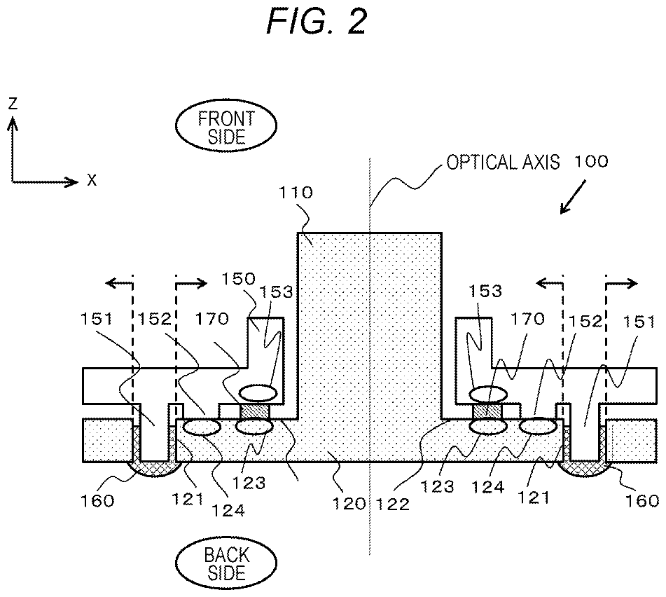

A first embodiment of an imaging device will be described below with reference to FIGS. 1 and 2.

FIG. 1 is an exploded perspective view of the imaging device 100. The imaging device 100 includes an optical lens 110, the lens holder 120, a substrate 130, an imaging element 140, and the housing 150. The optical lens 110 is fixed integrally to the lens holder 120, and the imaging element 140 is mounted on the substrate 130. The housing 150 includes a projection 151, and the projection 151 is inserted into an insertion hole 121 of the lens holder 120. The imaging device 100 includes two sets of the projection 151 and the insertion hole 121, the other of which is hidden in FIG. 1.

In the present embodiment, three axes X, Y, and Z are defined as illustrated in the upper left of FIG. 1. That is, the optical axis of the imaging device 100 is along a Z-axis, and the housing 150, the lens holder 120, and the substrate 130 are stacked in the Z-axis direction. The lens holder 120 and the substrate 130 are fixed in a state where the optical axis of the optical lens 110 integrated with the lens holder 120 is substantially perpendicular to an imaging surface of the imaging element 140, and a focal point of the optical lens 110 is substantially coincident with the imaging element 140. Subsequently, a detailed configuration of the imaging device 100 will be described with reference to FIG. 2.

FIG. 2 is a cross-sectional view of the imaging device 100. The substrate 130 is not illustrated in FIG. 2. The coordinates illustrated in the upper left of FIG. 2 are the same as those in FIG. 1. The imaging device 100 has a symmetrical configuration in FIG. 2 with the optical axis as a symmetry axis. In FIG. 2, a “front side” and a “back side” are defined in order to clearly indicate the direction of the lens holder 120. That is, a surface of the lens holder 120 facing a positive direction of the Z-axis is called the “front side” and a surface facing a negative direction of the Z-axis is called a “back side”. For example, the optical lens 110 is formed on the front side of the lens holder 120.

The projection 151, a first bonding portion 153, and a pressing portion 152, which is a reference plane on which the lens holder is mounted, are formed on the housing 150. The pressing portion 152 exists outside a region where an opening of the insertion hole 121 is extended in the axial direction of the insertion hole 121. Specifically, the broken line in FIG. 2 indicates a position where the edge of the opening of the insertion hole 121 is extended in the axial direction of the insertion hole 121, i.e., in the Z-axis direction, and the pressing portion 152 exists outside the broken line as illustrated by an arrow.

The insertion hole 121 penetrating from the front side to the back side and into which the projection 151 is inserted from the front side is formed in the lens holder 120. The front side of the lens holder 120 has a mounting reference plane 122 for the pressing portion 152. The reference plane 122 is provided with a pressed portion 124 in contact with a second bonding portion 123 and the pressing portion 152. FIG. illustrates that the second bonding portion 123 and the pressed portion 124 exist inside the lens holder 120 for convenience of illustration. However, the second bonding portion 123 and the pressed portion 124 exist on the reference plane 122 on the front side of the lens holder 120 as described above. The lens holder 120 is fixed to the housing 150 via a first adhesive agent 160 existing in the insertion hole 121 and a second adhesive agent 170 existing on the surface of the housing 150 where the pressing portion 152 exists.

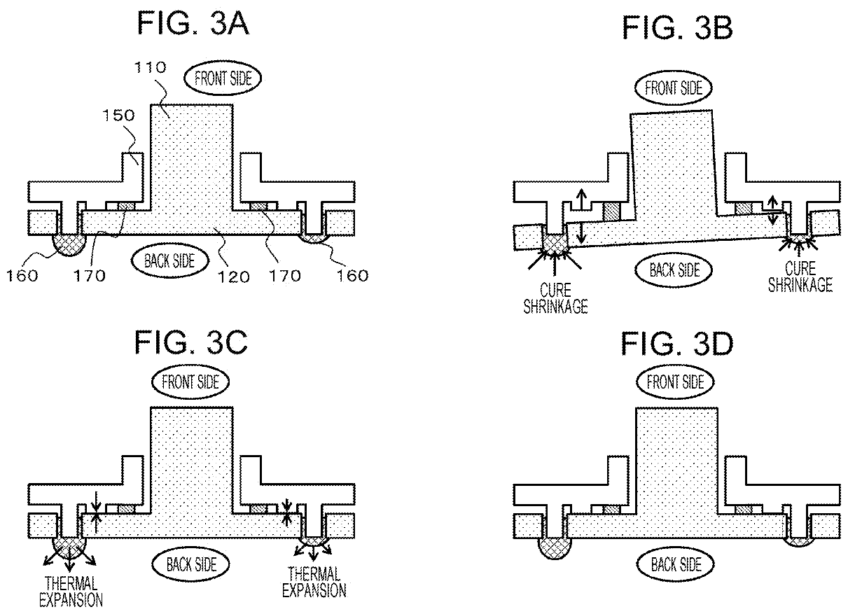

The structure of the imaging device 100 will be described again with reference to the two adhesive agents. The lens holder 120 and the housing 150 are fixed to each other by the first adhesive agent 160 and the second adhesive agent 170. The first adhesive agent 160 exists inside the insertion hole 121 and projects from the opening of the insertion hole 121 to the back surface. In other words, the first adhesive agent 160 projects from the inside of the insertion hole 121 to the back surface. The operations and effects of the projection of the first adhesive agent 160 to the back surface will be described later with reference to FIG. 3. The first adhesive agent 160 fixes the insertion hole 121 of the lens holder 120 and the projection 151 of the housing 150. However, the first adhesive agent 160 does not instantly fix them but only restrains them at an initial stage of bonding. The second adhesive agent 170 fixes the second bonding portion 123 of the lens holder 120 and the first bonding portion 153 of the housing 150.

The first adhesive agent 160 and the second adhesive agent 170 may be adhesive agents of different types or an adhesive agent of the same type. The second adhesive agent 170 is an adhesive agent at least having thermo-setting properties, and the first adhesive agent 160 is an adhesive agent at least having photo-setting properties. Furthermore, both the first adhesive agent 160 and the second adhesive agent 170 may be an adhesive agent having both photo-setting and thermo-setting properties. When the first adhesive agent 160 has thermo-setting properties, the first adhesive agent 160 has a property of curing at a lower temperature than the second adhesive agent 170 has. That is, both the first adhesive agent 160 and the second adhesive agent 170 may have only thermo-setting properties.

In general, it is ideal that the optical lens and the imaging element are fixed to the housing so that the optical axis of the optical lens is perpendicular to the mounting reference plane of the housing in the imaging device. Furthermore, it is desirable that a shift such as tilting does not occur in the optical axis even if the surrounding environmental temperature changes thereafter. In order to prevent the optical axis shift due to the change in the surrounding environmental temperature without impairing the assemblability at the time of manufacturing the imaging device, it is an effective method of temporarily fixing the optical components to the housing immediately after adjusting the position using a quick-curing adhesive agent such as a photo-setting adhesive agent, and subsequently, performing the final fixation using a stronger thermo-setting adhesive agent. However, in a case of undergoing a thermo-setting adhesive process involving heating of the entire device after the curing of the photo-setting adhesive agent, a positional shift may occur in the fixing positional relationship between the optical components and the housing due to thermal expansion of the photo-setting adhesive agent that has already been cured or cure shrinkage of the thermo-setting adhesive agent. In order to prevent such positional shift of the optical components, the above-described configuration is effective. With this configuration, the optical lens 110 forms an image of visual information obtained from the outside to the imaging element 140, and thus the imaging device 100 obtains an image of the outside.

### Assembly Process

FIG. 3 is a view describing an assembly process of fixing the lens holder 120 and the housing 150. (a) to (d) of FIG. 3 are arranged in time series, and the first state of the four is the state illustrated in FIG. 3(a), followed by the state illustrated in FIG. 3(b), and after the state illustrated in FIG. 3(c), the final state is the state illustrated in FIG. 3(d). FIG. 3(a) is a view illustrating a first process in which none of the adhesive agents has not been cured, FIG. 3(b) is a view illustrating a state in which only the first adhesive agent 160 has been cured, FIG. 3(c) is a view illustrating a state in which the second adhesive agent 170 is being cured, and FIG. 3(d) is a view illustrating a state in which all of the adhesive agents have been cured.

FIG. 3(a) is substantially the same as FIG. 2, except that the first adhesive agent 160 and the second adhesive agent 170 have not been cured in FIG. 3(a). That is, the pressed portion 124 of the lens holder 120 is in contact with the pressing portion 152 of the housing 150 on both the right and left sides in the drawing. In FIG. 3(a), in order to clarify the effect of this configuration, the amount of the first adhesive agent 160 is different on the right and left sides of the drawing. In FIG. 3(a), the projection amounts are extremely different, and it is difficult to make them exactly the same in reality. When the first adhesive agent 160 is irradiated with light having a predetermined wavelength and cured in the state illustrated in FIG. 3(a), the state illustrated in FIG. 3(b) is obtained.

As illustrated in FIG. 3(b), the first adhesive agent 160 cures when irradiated with light, and shrinks at this time. Since the first adhesive agent 160 projects to the back side, it shrinks to generate a force lifting upward in the drawing the projection 151 inserted into the insertion hole 121, and the pressed portion 124 of the lens holder 120 and the pressing portion 152 of the housing 150 are separated from each other. Since the amount of the first adhesive agent 160 is different between the right and left in the drawing as described above, the separation amount is different between the right and left. In the state illustrated in FIG. 3(b), when the imaging device 100 is heated in order to cure the second adhesive agent 170, the heat affects not only the second adhesive agent 170 but also the first adhesive agent 160, resulting in the state illustrated in FIG. 3(c).

As illustrated in FIG. 3(c), the first adhesive agent 160 thermally expands when heated. Since the first adhesive agent 160 projects to the back side, the first adhesive agent 160 moves the projection 151 downward in the drawing by thermal expansion. Due to this, the pressing portion 152 of the housing 150 moves downward in the drawing and comes into contact with the pressed portion 124 of the lens holder 120. After a while, the second adhesive agent 170 is cured and becomes in the state illustrated in FIG. 3(d). As illustrated in FIG. 3(d), since the second adhesive agent 170 is cured in a state in which the reference plane 122 is pressed against the pressing portion 152, the state in which the reference plane 122 and the pressing portion 152 are pressed is maintained even when the entire imaging device returns to room temperature after the thermo-setting process.

Since the imaging device 100 has such a configuration, there is no problem even if the application shape of the first adhesive agent 160 becomes unbalanced due to variations at the time of manufacturing as illustrated in FIG. 3, for example. This is because the lens holder 120 and the housing 150 can be fixed in a state where the mounting reference plane 122 of the lens holder is in parallel contact with the pressing portion 152. As illustrated in FIG. 3(b), when the application amount of the first adhesive agent 160 is unbalanced and the application amount on the left side of the drawing is larger, the force of shrinkage associated with a larger effect is generated on the left side of the drawing where the application amount is larger at the time of curing of the first adhesive agent 160, and the lens holder 120 and the housing 150 are temporarily in a state of being tilting.

However, subsequently in the process of thermally curing the second adhesive agent 170, the first adhesive agent 160 having already been cured thermally expands, thereby causing the lens holder 120 and the housing 150 to move in the direction of approaching each other. At this time, since the amount of expansion of the first adhesive agent 160 is larger than the amount of shrinkage of the first adhesive agent 160 at the time of curing, the reference plane 122 of the lens holder 120 is pressed against the pressing portion 152 provided in the housing 150, and the positional relationship between the lens holder 120 and the housing 150 is corrected.

Therefore, according to the configuration of the present invention, even when the shape of the adhesive agent becomes unbalanced due to variations at the time of manufacturing or the like, the lens holder 120 can be fixed to the pressing portion 152 corresponding to the mounting reference plane of the housing 150 without tilting.

According to the first embodiment described above, the following operations and effects can be obtained.

(1) The imaging device 100 includes the lens holder 120 and the housing 150. The imaging device 100 includes the insertion hole 121 provided in the lens holder 120 and penetrating from the front side to the back side, the projection 151 provided in the housing 150, inserted into the insertion hole 121 from the front side, and bonded to the first substrate by the first adhesive agent 160, the pressed portion 124 provided on the front side of the lens holder 120 and in contact with the housing 150, the pressing portion 152 provided in the housing 150 and in contact with the lens holder 120, the second bonding portion 123 provided on the front side of the lens holder 120 and bonded to the housing 150 by the second adhesive agent 170, and the first bonding portion 153 provided in the housing 150 and bonded to the lens holder 120 by the second adhesive agent 170. The first adhesive agent 160 projects from the inside of the insertion hole 121 to the back side. Therefore, as described with reference to FIG. 3, it is possible to suppress a shift of the fixing position of the optical component that occurs when the adhesive agent is cured.

(2) The pressing portion 152 exists outside the region where the opening of the insertion hole 121 is extended in the axial direction of the insertion hole 121. Therefore, even when the first adhesive agent 160 overflows from the insertion hole 121, there is a gap between the insertion hole 121 and the pressing portion 152, and hence the first adhesive agent 160 can be prevented from reaching the pressing portion 152 and inhibiting the close contact between the pressing portion 152 and the pressed portion 124. A comparative example will be described with reference to the drawings to assist in understanding this feature.

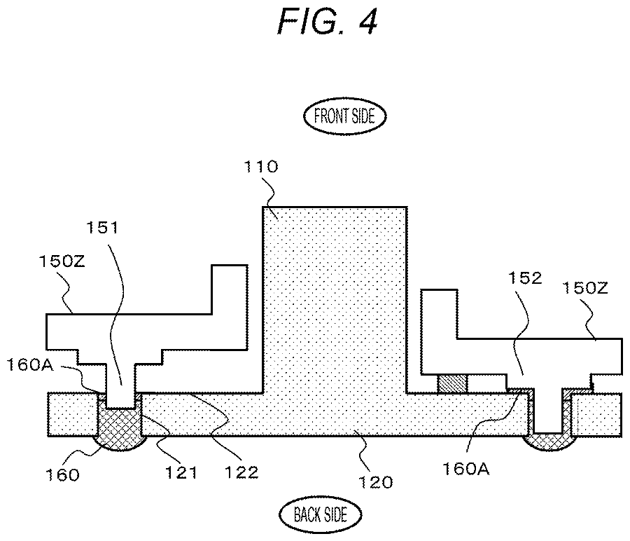

FIG. 4 is a view illustrating the comparative example. FIG. 4 illustrates different time series on the right and left of the drawing. In FIG. 4, among the first adhesive agents 160, a first adhesive agent existing in the vicinity of the front side of the insertion hole 121 is denoted by a reference numeral 160A. A housing in this comparative example is denoted by a reference numeral 150Z, and its name is a “comparison housing”. The comparison housing 150Z has the pressing portion 152 formed on an extension line of the insertion hole 121.

When the projection 151 of the comparison housing 150Z is inserted inside the insertion hole 121 as illustrated in the left of FIG. 4, the first adhesive agent 160 inserted into the insertion hole 121 may project slightly not only on the back side but also on the front side. When the projection 151 of the comparison housing 150Z is further inserted into the insertion hole 121 as illustrated in the right of FIG. 4, the first adhesive agent 160A overflowing from the insertion hole 121 enters the gap between the pressing portion 152 and the reference plane 122, and the pressing portion 152 cannot be pressed against the reference plane 122. Since such a problem may occur, in the present embodiment, the pressing portion 152 is formed outside the region where the opening of the insertion hole 121 is extended in the axial direction of the insertion hole 121.

(3) The first adhesive agent 160 is a photo-setting adhesive agent, and the second adhesive agent 170 is a thermo-setting adhesive agent. Therefore, the first adhesive agent 160 can be easily cured first. As described in the example, the first adhesive agent 160 needs to be cured before the second adhesive agent 170. If the second adhesive agent 170 does not have photo-setting properties, the entire imaging device 100 can be irradiated with light to cure only the first adhesive agent 160 first. Even if the second adhesive agent 170 has photo-setting properties, it is possible to prevent the second adhesive agent 170 from curing simultaneously with the first adhesive agent 160 or the second adhesive agent 170 from curing before the first adhesive agent 160, by using a shielding plate or a light shielding sheet.

### First Modification

In the above-described first embodiment, the second bonding portion 123 and the pressed portion 124 are formed on the same surface. However, the pressed portion 124 may project relative to the second bonding portion 123. In this case, the tip of the projecting pressed portion 124 becomes the reference plane 122.

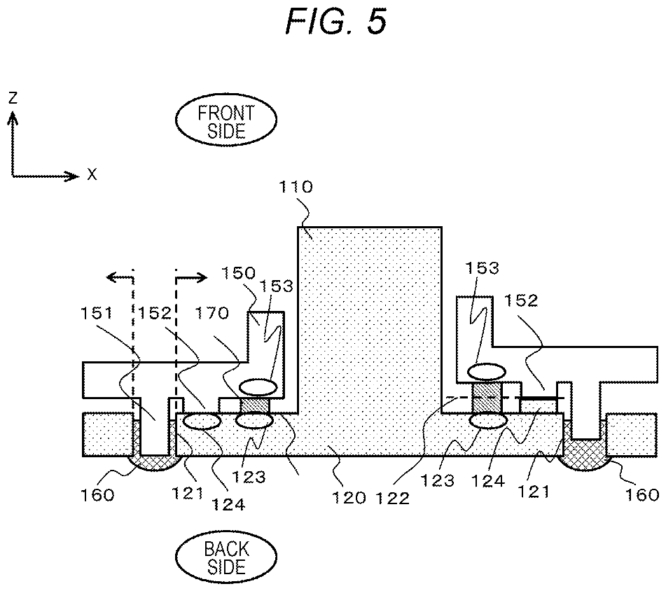

FIG. 5 is a cross-sectional view of the imaging device 100 according to the first modification. However, for comparison, the configuration of the first embodiment is illustrated on the left side of the drawing, and the configuration of the first modification is illustrated only on the right side of the drawing. As illustrated in FIG. 5, the reference plane 122 exists away from both the end surface of the lens holder 120 and the end surface of the housing 150. The projection of the pressing portion 152 from the first bonding portion 153 may be eliminated. In this case, the reference plane 122 coincides with the end surface of the housing 150.

### Second Embodiment

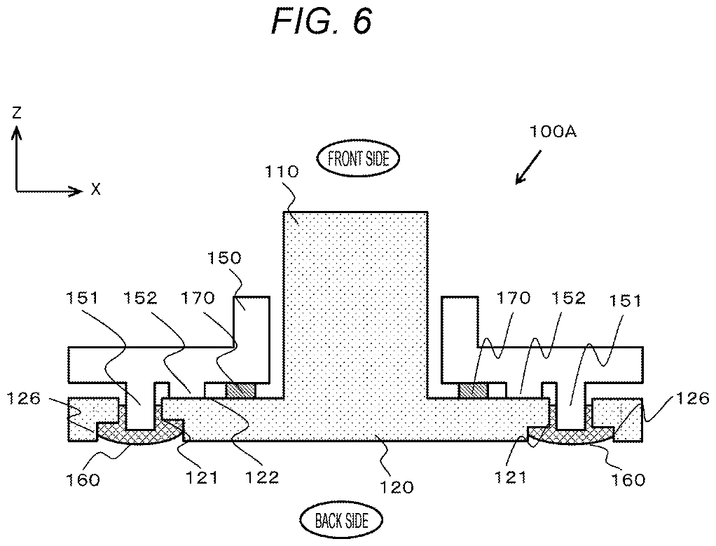

The second embodiment of the imaging device will be described with reference to FIG. 6. In the following description, the same components as those of the first embodiment are denoted by the same reference numerals, and differences will be mainly described. Points not particularly described are the same as those in the first embodiment. The present embodiment is different from the first embodiment mainly in that a counterbore is formed in the vicinity of the insertion hole.

FIG. 6 is a cross-sectional view of an imaging device 100A according to the second embodiment, and corresponds to FIG. 2 according to the first embodiment. As illustrated in FIG. 5, the lens holder 120 in the second embodiment has a counterbore 126 centered on the insertion hole 121 on the back side. The point that the insertion hole 121 penetrates from the front side to the back side of the lens holder 120 is the same as in the first embodiment. By adjusting the application amount of the first adhesive agent 160 so that the projection amount of the first adhesive agent 160 to the back side falls within the inside of the counterbore 126, it is possible to eliminate the projection of the first adhesive agent 160 to the back side of the lens holder 120, and to prevent the surface in contact with the back side of the lens holder 120 from being stained.

According to the second embodiment described above, the following operations and effects can be obtained.

(4) On the back side of the lens holder 120, the counterbore 126, which is a recess, is formed around the opening of the insertion hole 121. The first adhesive agent 160 projects from the inside of the insertion hole 121 to the counterbore 126. Therefore, the surface in contact with the back side of the lens holder 120 can be prevented from being stained.

### Third Embodiment

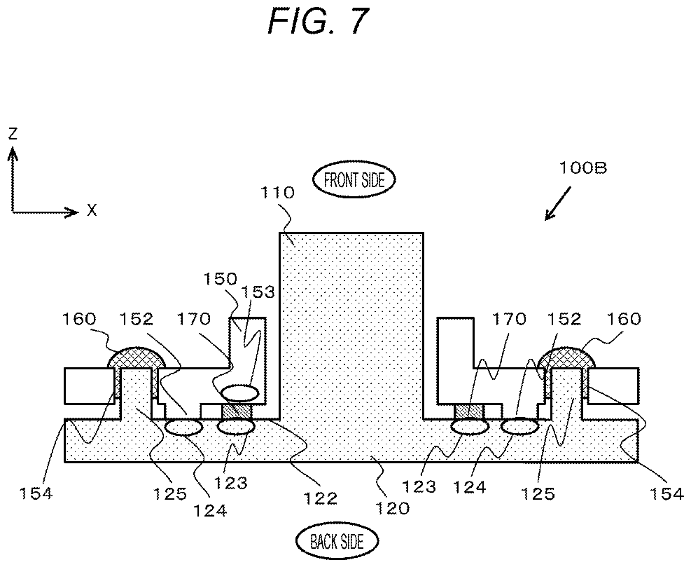

The third embodiment of the imaging device will be described with reference to FIG. 7. In the following description, the same components as those of the first embodiment are denoted by the same reference numerals, and differences will be mainly described. Points not particularly described are the same as those in the first embodiment. The present embodiment is different from the first embodiment mainly in that the positional relationship between the insertion hole and the projection is switched.

FIG. 7 is a cross-sectional view of an imaging device 100B according to the third embodiment, and corresponds to FIG. 2 according to the first embodiment. As illustrated in FIG. 7, a projection 125 is formed in the lens holder 120, and an insertion hole 154 into which the projection 125 is inserted is formed in the housing 150. The reference plane 122 of the lens holder 120 comes into contact with the pressing portion 152. The lens holder 120 is fixed to the housing 150 via the first adhesive agent 160 existing in the insertion hole 154 and the second adhesive agent 170 existing on the surface of the housing 150 where the pressing portion 152 exists. The first adhesive agent 160 projects from the front side of the housing 150.

(5) The imaging device 100B includes the lens holder 120 and the housing 150. The shooting device 100B includes the insertion hole 154 provided in the lens holder 120 and penetrating from the back side to the front side, the projection 125 provided in the housing 150, inserted into the insertion hole 154 from the back side, and bonded to the housing 150 by the first adhesive agent 160, the pressed portion 124 provided on a surface of the lens holder 120 opposed to the housing 150 and in contact with the housing 150, the pressing portion 152 provided in the housing 150 and in contact with the lens holder 120, a first bonding portion 123 provided on the surface of the lens holder 120 opposed to the housing 150 and bonded to the housing 150 by the second adhesive agent 170, and a second bonding portion 153 provided in the housing 150 and bonded to the lens holder 120 by the second adhesive agent 170. The first adhesive agent 160 projects from the inside of the insertion hole 154 to the front side. Since the first adhesive agent 160 does not project to the back side of the lens holder 120, the imaging device 100B is effective in preventing the optical lens from being stained.

### Fourth Embodiment

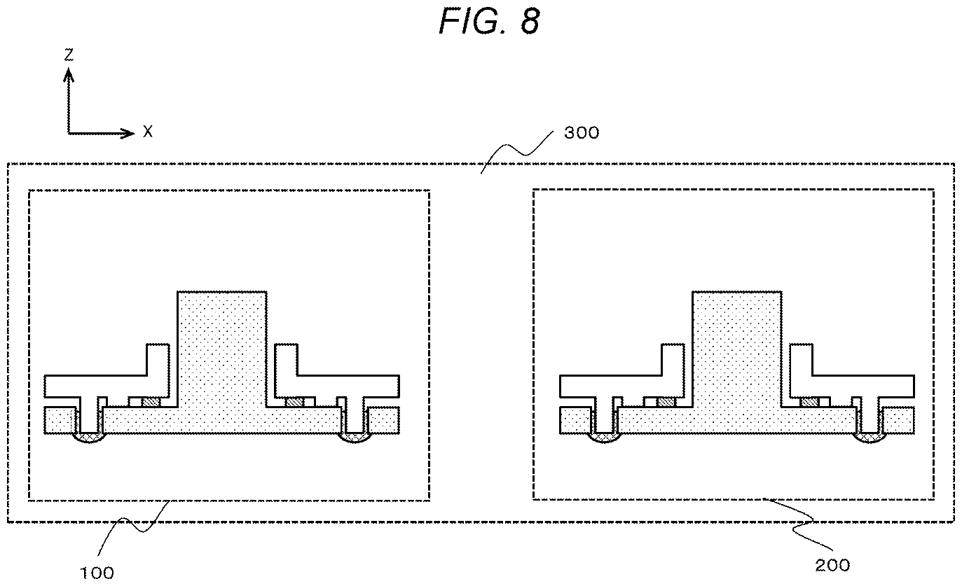

A fourth embodiment of the imaging device will be described with reference to FIG. 8. In the following description, the same components as those of the first embodiment are denoted by the same reference numerals, and differences will be mainly described. Points not particularly described are the same as those in the first embodiment. The present embodiment is different from the first embodiment mainly in that two imaging devices are combined.

FIG. 8 is a schematic view of the multi-eye imaging device 300 including two imaging devices. As illustrated in FIG. 8, in the multi-eye imaging device 300, the imaging device 100 and an imaging device 200 are arranged side by side so that their optical axes are substantially parallel to each other. The imaging device 200 has the identical configuration to that of the imaging device 100, but different reference numerals are used here for convenience. At this time, the pressing portion 152, the projection 151, and the insertion hole included in the imaging device 100 and the imaging device 200 are arranged at two or more positions side by side at least in a baseline length direction. Here, the baseline length direction is a direction in which the imaging device 100 and the imaging device 200 are arranged.

The multi-eye imaging device 300 detects a coincidence point of two images acquired by the imaging device 100 and the imaging device 200, and obtains a parallax of the both images. Then, the distance to the subject is calculated from the amount of parallax occurring in the baseline length direction. Accordingly, in the multi-eye imaging device 300, it is desirable that the optical axes of the two imaging devices are parallel to each other. If the optical axis is tilted in the baseline length direction, the distance calculation accuracy decreases.

According to the fourth embodiment described above, the following operations and effects can be obtained. (6) The multi-eye imaging device 300 is configured with the imaging device 100 and the imaging device 200 arranged side by side so that their optical axes are substantially parallel to each other. When the direction in which the imaging device 100 and the imaging device 200 are arranged is the baseline length direction, the projection 151, the insertion hole 121, and the pressing portion 152 are arranged side by side at two or more places in the baseline length direction. Since the tilt in the baseline length direction is particularly suppressed by the pressing portion 152, the projection 151, and the insertion hole 121 formed side by side in the baseline length direction, it is possible to prevent reduction in the distance calculation accuracy of the multi-eye imaging device 300.

While various embodiments and modifications have been described above, the present invention is not limited to those contents. Other aspects conceivable within the scope of the technical idea of the present invention are also included within the scope of the present invention.

The disclosure of the following priority application is herein incorporated by reference.

Japanese Patent Application No. 2017-205511 (filed on 24 Oct. 2017)

### REFERENCE SIGNS LIST

100, 100a, 100b imaging device
110 optical lens
120 lens holder
121 insertion hole
122 reference plane
123 bonding portion
124 pressed portion
125 projection
126 counterbore
130 substrate
140 imaging element
150 housing
151 projection
152 pressing portion
153 bonding portion
154 insertion hole
160 first adhesive agent
170 second adhesive agent
300 multi-eye imaging device

1. An imaging device having a first substrate and a second substrate, the imaging device comprising:
an insertion hole provided to the first substrate and penetrating from a first side to a second side;
a projection provided to the second substrate, inserted into the insertion hole from the first side, and bonded to the first substrate by a first adhesive agent;
a first contact portion provided to the first substrate and in contact with the second substrate;
a second contact portion provided to the second substrate and in contact with the first contact portion in the first substrate;
a first bonding portion provided to the first substrate and bonded to the second substrate by a second adhesive agent; and
a second bonding portion provided to the second substrate and bonded to the first bonding portion in the first substrate by the second adhesive agent,
wherein the first adhesive agent projects from an inside of the insertion hole to the second side.

2. The imaging device according to claim 1, wherein
the first substrate is a lens holder, and
the second substrate is a housing.

3. The imaging device according to claim 1, wherein
the first substrate is a housing, and
the second substrate is a lens holder.

4. The imaging device according to claim 1, wherein the second contact portion exists outside a region where an opening of the insertion hole is extended in an axial direction of the insertion hole.

5. The imaging device according to claim 1, wherein
the first adhesive agent is a photo-setting adhesive agent, and
the second adhesive agent is a thermo-setting adhesive agent.

6. The imaging device according to claim 1, wherein the second adhesive agent has a curing start temperature higher than that of the first adhesive agent.

7. The imaging device according to claim 1, wherein the first adhesive agent and the second adhesive agent are photo-thermo-setting adhesive agents having both photo-setting properties and thermo-setting properties.

8. The imaging device according to claim 1, wherein
a counterbore, which is a recess, is formed around an opening of the insertion hole on the second side, and
the first adhesive agent projects from an inside of the insertion hole to the counterbore.

9. A multi-eye imaging device, comprising:
two of the imaging devices according to claim 1, wherein
the two imaging devices are arranged so that their optical axes are substantially parallel, and
at least two of the projection, the insertion hole, and the first contact portion are arranged side by side in a direction connecting the two imaging devices.
